(19) United States
(12) Patent Application Publication
(10) Pub. No.: US 2012/0234538 A1
(43) Pub. Date: Sep. 20, 2012

(54) COMPOSITE FRAC BALL

(75) Inventors: Tracy Martin, Houston, TX (US); Jesus Ignacío Chavez, Rosharon, TX (US)

(73) Assignee: General Plastics & Composites, LP, Houston, TX (US)

(21) Appl. No.: 13/327,723

(22) Filed: Dec. 15, 2011

Related U.S. Application Data
(60) Provisional application No. 61/452,276, filed on Mar. 14, 2011.
(60) Provisional application No. 61/531,518, filed on Sep. 6, 2011.

(51) Int. Cl. E21B 33/13; B29C 70/40; E21B 33/12

(52) U.S. Cl. 166/284; 166/193; 264/258

(57) ABSTRACT

Herein disclosed is a frac ball comprising three orthogonal axes x, y, and z; wherein the frac ball has approximately equal strength in each direction of the three axes x, y, and z. In an embodiment, the frac ball comprises a resin. In an embodiment, the frac ball comprises glass fibers or carbon fibers or both. In an embodiment, the frac ball comprises an equal amount of glass fibers in each direction of the x, y, and z axes. In an embodiment, the frac ball comprises glass fibers in the x and y axes and carbon fibers in the z axis. In an embodiment, the frac ball comprises no interlaminar layers. In an embodiment, the frac ball has different diameters. Also disclosed herein are methods of making and using such frac balls.

### CROSS REFERENCE TO RELATED PATENTS

This application claims the benefit under 35 U.S.C. §119(e) of U.S. Provisional Patent Application Nos. 61/452,276 filed Mar. 14, 2011 and 61/531,518 filed Sep. 6, 2011, the disclosure of said applications is hereby incorporated herein by reference.

### STATEMENT REGARDING FEDERALLY SPONSORED RESEARCH OR DEVELOPMENT

Not applicable.

### BACKGROUND

1. Field of the Invention

This invention relates to fracturing balls and method of use; specifically it relates to composite fracturing balk and applications thereof.

2. Background of the Invention

Completion tools in oil and gas wellbores have used fracturing (frac) balls as a means of isolating one portion of the completion string from another in order to perform a certain task or treat a reservoir. A completion string is a number of different tools, such as screens, valves and packers, which are usually coupled together and set overlapping an oil or gas reservoir in a wellbore, with the purpose of extracting as much of either fluid as possible. A few of the tasks mentioned above are, but not limited to, setting a packer, releasing from it, shifting a valve from one position to another, or fracturing a reservoir, high pressure will most likely be applied on one side of the ball, thereby, creating large contact stresses on the opposite side of the ball.

Permanent completion equipment is typically made out of some type of high yield alloy due mostly to the fact that these tools will remain down hole permanently. Because permanent completion equipment is manufactured out of metal, making it relatively heavy, the service equipment used to lower the completion string into place is also manufactured out of metal. Service equipment is also designed to be reused; therefore, it is manufactured out some type of high yield alloy. Metallic balls have been used as the isolation means on this type of completion.

Once the completion is in place, lowered by and still attached to the service string, a metallic ball is dropped down hole. The relatively heavy ball travels through fluids of varying density, depending on the reservoir, and lands on its associated seat, somewhere near the top of the service string. After the tasks and treatments are performed the service string is raised out of the wellbore, with the ball still captured on the metal seat.

On reservoirs where expensive and complicated permanent completion equipment is not required, soft metal drillable tools have been used, such as cast iron or aluminum. These tools are lowered into place and mechanically set. The ball would then be dropped, in a manner very similar to the scenario explained above. In this case however the ball would, as the plug, have to be made out of material with similar to or better drill-ability characteristics. Plastic balls have been used in this scenario with success.

With the advent of drillable composite tools, the drill-ability of the tools was increased dramatically. Aside from the difference in material, these tools function operationally just like the soft metal ones described above. Plastic balls have been used in this scenario, also with success.

Great advances in the field of down-hole composites have been made since the introduction of the drillable composite tool. Down hole composites have evolved to the point where they are commonly used in the harshest of wellbore conditions; however, composites, when exposed to fluids and temperature, will deteriorate in weeks or months (depending on temperature extremes and type of fluids) versus years as is the case with metal completions. The combination of advancement of down-hole composites, along with the technological breakthroughs in horizontal drilling, has pushed certain composite applications to the limit. The typical composite frac ball is one of these applications.

Horizontal drilling technology was developed in order to maximize the amount of reservoir fluid accessible with one wellbore completion. Reservoirs, typically, are found in horizontal layers that run parallel with the earth's crust. Several vertical wellbore completions would have to be drilled in order to match the reservoir accessible area of one horizontal completion that runs through and along most of the reservoir. Hence horizontal completions are inherently more efficient than vertical ones. The main issue, in this case, is how to economically fracture and treat a horizontal reservoir without expensive completion equipment or multiple trips down hole. The solution to that issue is a series of mechanisms that run the length of the horizontal completion, each mechanism descending in size the deeper it lays into the wellbore. The wellbore area directly up-hole sofa mechanism is described as that mechanism's “zone”; horizontal wellbores may easily require twenty or more zones. The smallest ball would be dropped first and pumped down hole, since gravity will not be of assistance in a horizontal wellbore, until it reaches the first mechanism near the “toe” (farthest point from the vertical section of the well). Once in place, fluid pressure is increased from above (fluid pressure is increased from the “heel” end of the wellbore, opposite to the side of the ball in contact with the ball seat), causing the activation of the first mechanism, followed by the fracturing and treatment of the reservoir's “zone”, in a direction perpendicular to the wellbore. The longer a horizontal wellbore is, the more of these mechanisms will be required to maximize the fracturing/treatment areas. Therefore, the associated ball seats require a maximized ID (inner diameter) in order to let the preceding frac ball through; in turn the maximized ID directly leads to a minimized contact surface area between the seat and frac ball, which generate large stresses. Typical composite and plastic frac balls have proved to have insufficient compressive and shear strengths to meet these demanding requirements.

Consequently, industry has been in search of a high strength composite ball without success. Conventional completions (typically vertical to deviated wellbores constructed out of metal completion tools) have for the most part relied on metallic balls, which could be dropped into the well from the rig floor and essentially float down or be pumped down onto the seat; however, this approach becomes unpractical in horizontal wellbores. The heavy metallic frac ball would lie on the wellbore bottom and pumping it onto a seat, concentric with the wellbore, is unreliable. Depending on the reservoir, a requirement may also exist to have the reservoir production fluid carry the ball back up-hole. This would be improbable for using a heavy metal frac ball. Again depending on the reservoir, a requirement may exist that would require the ball to be drilled out after concluding the treatments. This would require the ball to be manufactured out of composites or soft metals such as aluminum or cast iron; hence, the use of a metal frac ball would not be practical, since they would most likely greatly increase each zone's drill out time. Therefore, there is continuing need and interest in developing frac balls suitable for various applications.

### SUMMARY

Herein disclosed is a frac ball comprising three orthogonal axes x, y, and z; wherein the frac ball has approximately equal strength in each direction of the three axes x, y, and z. In an embodiment, the frac ball comprises a resin. In an embodiment, the frac ball comprises glass fibers or carbon fibers or both. In an embodiment, the frac ball comprises an equal amount of glass fibers in each direction of the x, y, and z axes. In an embodiment, the frac ball comprises glass fibers in the x and y axes and carbon fibers in the z axis. In an embodiment, the frac ball comprises no interlaminar layers. In an embodiment, the frac ball has different diameters.

Herein disclosed is a method of producing a frac ball wherein the frac ball comprises three orthogonal axes x, y, and z and wherein the frac ball has approximately equal strength in each direction of the three axes x, y, and z. In an embodiment, the method producing the frac ball out of a billet. In an embodiment, the billet is created by stacking layers of three dimensionally woven laminate; adding resin in between the laminate layers; compressing the stack of laminate layers with resin; and curing the compressed stack. In an embodiment, the billet comprises only one layer of three dimensionally woven laminate and no interlaminar layers. In an embodiment, the method comprises producing frac balls of different diameters. In an embodiment, the frac ball comprises glass fibers or carbon fibers or both. In an embodiment, the frac ball comprises an equal amount of glass fibers in each direction of the x, y, and z axes. In an embodiment, the frac ball comprises glass fibers in the x and y axes and carbon fibers in the z axis.

Further disclosed herein is a method of using a frac ball wherein the frac ball comprises three orthogonal axes x, y, and z and wherein the frac ball has approximately equal strength in each direction of the three axes x, y, and z. In an embodiment, the method comprises utilizing the frac ball to service an oilwell. In an embodiment, the method comprises utilizing the frac ball in horizontal drilling. In an embodiment, the method comprises utilizing the frac ball in multi-zone completion. In an embodiment, the method comprises utilizing more than one of the frac balls of different sizes.

These and other embodiments, features and advantages will be apparent in the following detailed description and drawings.

### BRIEF DESCRIPTION OF THE DRAWINGS

For a more detailed description of the present invention, reference will now be made to the accompanying drawings, wherein:

FIG. 1A: Cloth Wrapped Tubular Composite Material Lay-Up, Isotropic View, according to an embodiment of this disclosure;

FIG. 1B: Filament/Tape Wound Tubular Composite Material Lay-Up, Isotropic View, according to an embodiment of this disclosure;

FIG. 1C: Tubular Composite Laminate Detail, End View or Section taken Perpendicular to Axis 1-1, according to an embodiment of this disclosure;

FIG. 1D: Material Loading and Interlaminar Shear, Section View taken along Axis 1-1, according to an embodiment of this disclosure;

FIG. 2A: 2D Cloth Layered Plate Composite Material Lay-Up, Isotropic View, according to an embodiment of this disclosure;

FIG. 2B: 2D Cloth Layered Plate Composite Material Lay-Up, End View parallel to 28, according to an embodiment of this disclosure;

FIG. 3: Hand Sketch detailing the “Z’ Fiber's Path through the Plate, Front View Cross Section, according to an embodiment of this disclosure;

FIG. 4: Hand Sketch Detailing the Forces Produced by a Ball Seat, Front View Cross Section, according to an embodiment of this disclosure;

FIG. 5: Three Dimensionally Woven Plate Material, equal percentage of material in each axis, Isotropic View, according to an embodiment or this disclosure;

FIG. 6: Stacked/Layered Three Dimensionally Woven Plate Material, Isotropic View, according to an embodiment of this disclosure;

FIG. 7: Two Dimensionally Woven Reinforced Ball on Metal Seat with 45 Degree Seat Angle, the “X” Fiber is Parallel to the Ball Seat Contact Plane, Front View Cross Section, according to an embodiment of this disclosure;

FIG. 8: Compression Mold Used to Make 2D and 3D Laminate, Front View Cross Section, according to an embodiment of this disclosure;

FIG. 9: Three Dimensionally Woven Reinforced Ball before Landing on Metal Scat with 45 Degree Seat Angle, the “Z” Fiber is Perpendicular to the Ball Seat Contact Plane, Front View Cross Section, according to an embodiment of this disclosure;

FIG. 10: Two Dimensionally Woven Reinforced Ball on Metal Seat, Interlaminar Shear Layers are Oriented Perpendicular to the Ball Seat Contact Plane, Front View Cross Section, according to an embodiment of this disclosure;

FIG. 11: Three Dimensionally Woven Reinforced Ball on Metal Scat with 45 Degree Scat Angle, the “Z” Fiber is Perpendicular to the Ball Seat Contact Plane, Front View Cross Section, according to an embodiment of this disclosure:

FIG. 12: Three Dimensionally Woven Reinforced Ball on Metal Seat with 45 Degree Seat Angle, the “Z” Fiber is Oriented at a Random Angle to the Ball Seat Contact Plane, Front View Cross Section, according to an embodiment of this disclosure:

FIG. 13: Three dimensionally Woven Plate Material, approximately 14-15% in ‘Z” direction, equal in “X” and “Y”, Isotropic View, according to an embodiment of this disclosure;

FIG. 14: Three dimensionally Woven Plate Material, approximately 14-15% in ‘Z” direction, equal in “X” and “Y”, Isotropic View, close up on “Z” fiber, according to an embodiment of this disclosure:

FIG. 15: Three dimensionally Woven Plate Material, approximately 33% in all three directions, isotropic View, close up on “Z” fiber, according to an embodiment of this disclosure.

### DETAILED DESCRIPTION

Manufacturing methods and means of improving mechanical strengths of plastic balls will not be addressed in the remainder of this disclosure. Plastic balls are manufactured, in general, by molding a compound at a predetermined temperature over a period of time. To this day, a molding compound that yields the required strengths for a reliable down-hole ball is unknown.

Relatively light weight composite balls may be made using several different methods: all sharing the same principle: reinforcing material and a resin. The reinforcing material may be any of a large number of materials commonly used in composite manufacturing. Glass and carbon fiber are common reinforcing base materials. Either is available in two or three dimensionally woven cloths, filaments (yarn) and tape forms. Additionally, woven cloths, filaments, and tape forms each have a large number of configurations available. For oil and gas wellbore applications, epoxy resins are commonly used for the elevated temperature and pressure requirements. Generally, epoxy resins have good chemical resistance, which is required in this application.

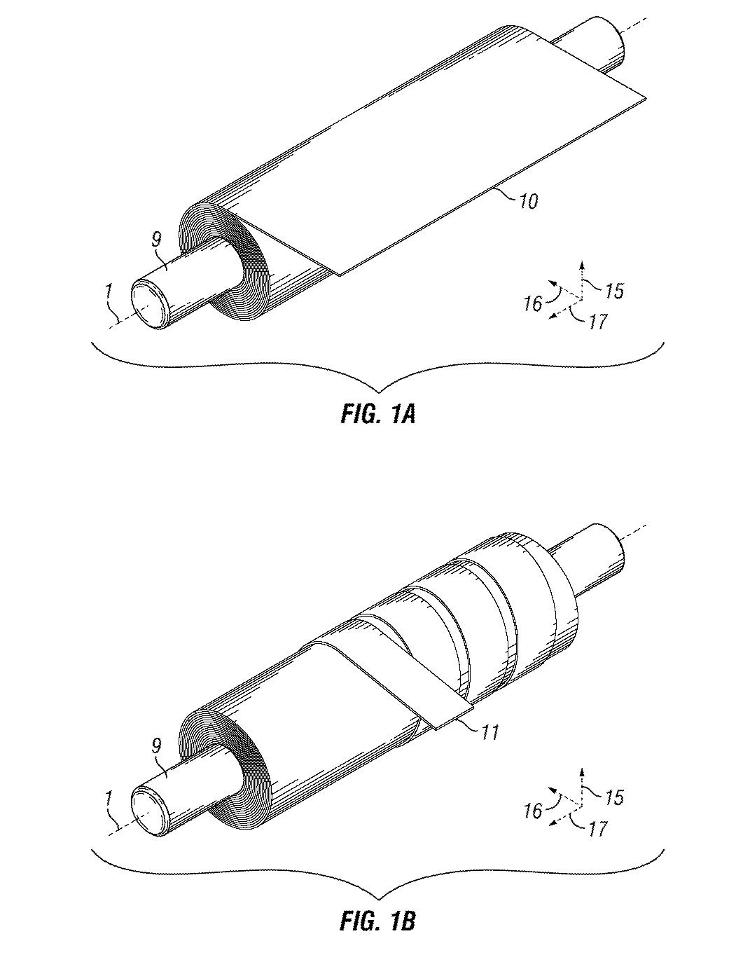

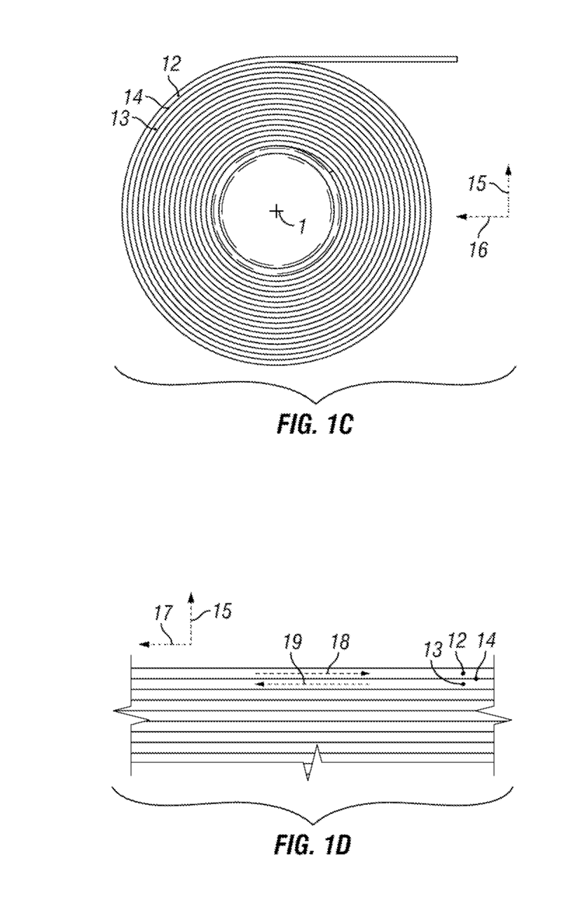

The following describes the different methods for manufacturing composite material, which may be used to manufacture a frac ball. FIG. 1A illustrates the construction of tubular composites used in the oil and gas wellbore tools. The tubular composite may be constructed by wrapping a two or three dimensionally woven cloth around a tooling mandrel 9 with the addition of resin 14 (see FIG. 1C) during (wet wrapping) or after (resin transfer molding (RTM)) wrapping. Alternatively as shown in FIG. 1B, tubular composite may be constructed by the process of filament/tape winding, wherein reinforcing filaments 11 are wound around the tooling mandrel 9 with the addition of resin 14.

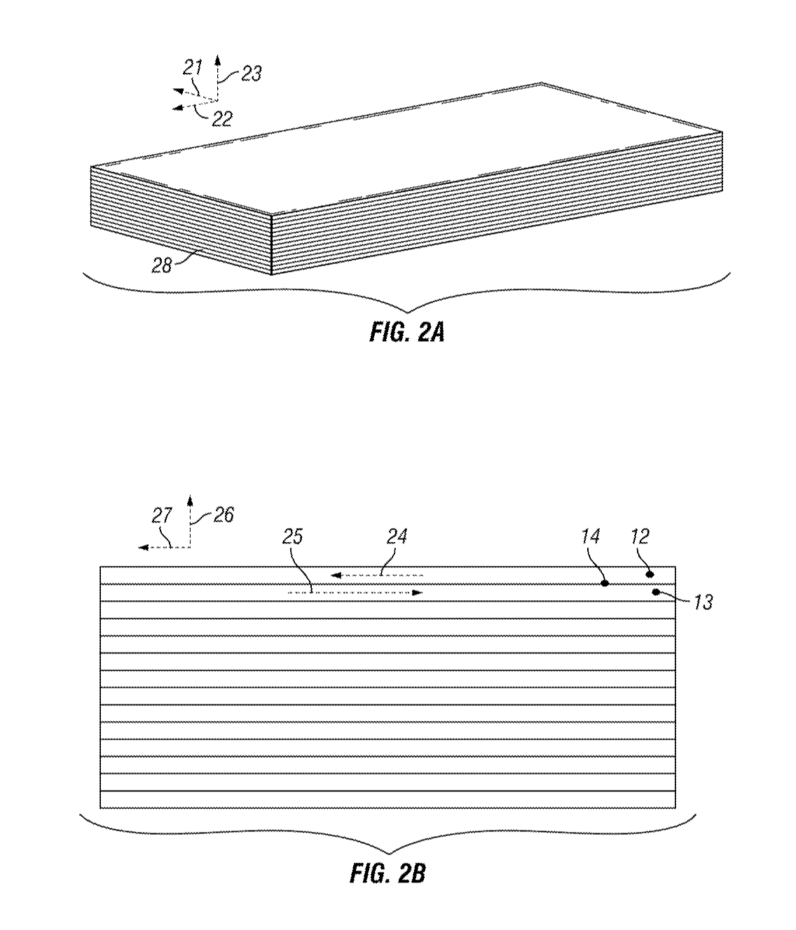

The two methods discussed below produce plate type material versus the fore mentioned tubular type. FIG. 2A illustrates the construction of layered plate composites used in oil and gas wellbores. Plate material is constructed by stacking layers of two dimensional woven cloth on top of one another with the addition of resin 14 (wet layup) or after (RTM or vacuum assisted resin transfer molding (VARTM)). Similarly FIGS. 8A and 813 illustrate compressed-plate material 29 being constructed by stacking layers of two dimensional woven cloth on top of one another in a compression mold, with the addition of resin 14 (wet layup) or after (RTM or VARTM).

Once combined in tubular or plate form, the material is subjected to heat in order to harden the resin system. This hardening is known as “curing”. Curing requirements are determined by the resin system used. The composite material may then be post-cured for improved properties.

Material produced in this manner is referred to as a laminate within the industry. A laminate has layers of reinforcing material 12 and 13 with a resin bonding layer 14 between them as shown in FIG. 1C and FIG. 1D. The area between any two layers is referred to as an interlaminar area.

The material properties of laminates 12, 13 are typically anisotropic. An anisotropic material is one with properties that vary based upon orientation. Referring to FIGS. 1A and 1C and 1D, the material properties in tubular composites are oriented in radial 15, circumferential 16 and axial 17 directions. Similarly, referring to FIGS. 2A and 2B, the material properties in plate composites are oriented along the planes created between each layer of cloth, in this case the orientation is in two directions, 21 and 22. Both scenarios are constructed using relatively thin two dimensionally woven material resulting in a large number of interlaminar layers.

The load condition applied to a laminate, will determine the performance since the mechanical properties of laminate differ in each direction. In FIG. 1D, when load is applied to the laminate 12, 13, and 14 in an axial direction 17 such that the two adjacent layers 12, 13 are subjected to opposing loads 18, 19 where the load 19 condition is termed an interlaminar shear. The interlaminar shear occurs in the resin 14 that bonds the two layers together. The strength of the material at the interlaminar area is signifimaytly less than the strength in other directions, 15, 16 (FIG. 1C). In a tubular composite, the interlaminar shear condition occurs in a direction 17 along the axis of the tube formed by the cross-section 1-1 of FIG. 1A. Similarly in plate material, the interlaminar shear condition exists in between each layer and in two directions 21, 22, not just along axis 1-1 as in FIG. 1A; since plate material is not bound circumferentially as is tubular material. A frac ball machined out of the relatively thick wall of tubular material or out of the plate material would be subjected to interlaminar shear when in contact with its associated ball seat.

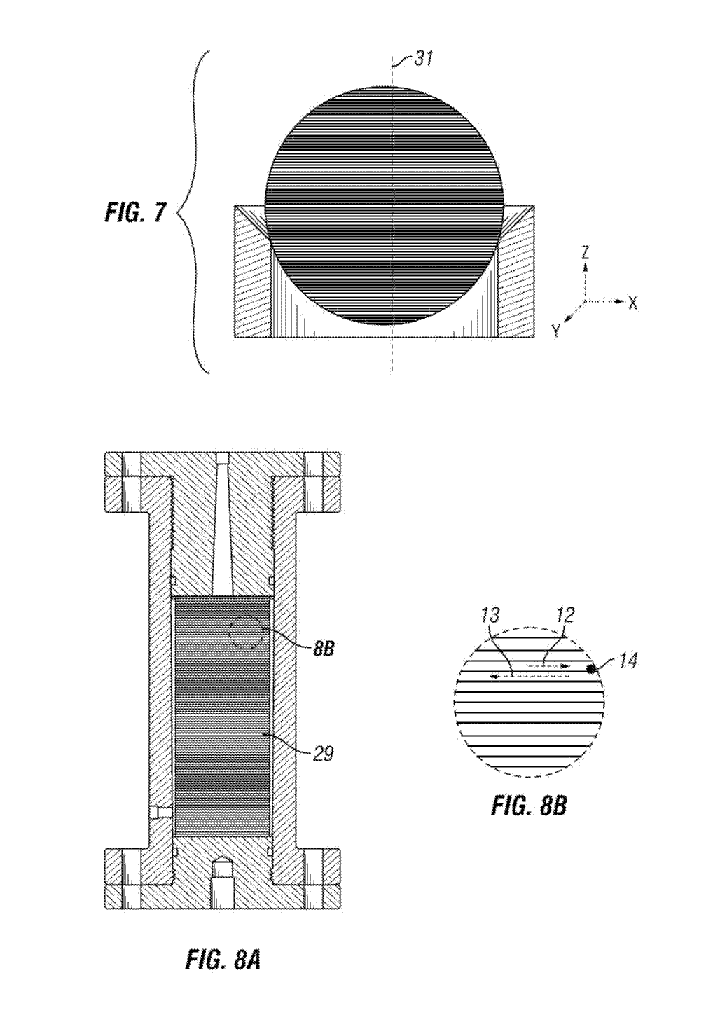

Since the material's strength is signilimaytly less in the interlaminar area than in other directions, such as radial 15, circumferential 16 in FIG. 1C or perpendicular to plate 26 in FIG. 2B, the overall strength of the laminate may be increased by one of two methods. The first method is by reducing the quantity of interlaminar areas, the second is achieved by ensuring the load is always applied perpendicular to the interlaminar shear area, as in 26 in FIG. 23 or 15 and 16 in FIG. 1C. The second method is not practical since the shape of the object in question is a sphere; which will be dropped down-hole and pumped onto a seat oriented perpendicular to the horizontal wellbore. There is no practical way to consistently land a layered composite ball on a seat while ensuring that the interlaminar areas (layers) land parallel to the ball seat plane as shown in FIG. 7. The more practical approach is to reduce the quantity of interlaminar areas, which is the most effective way to achieve the goal. Generally, two dimensionally woven cloths produce relatively thin reinforcement cloth, resulting in multi-layered laminate. Thicker cloth will produce laminate with less number of interlaminar shear areas: hence a stronger laminate.

Overview. Advances in oil and gas technology have drastically changed the requirements for fracturing balls in the industry. Frac balls are now required to withstand the same harsh environments and high pressure treatments as before but on a much larger ball seat ID. The maximized ball seat ID, while practical to the application, generates maximized contact stresses on the ball due to the minimized surface area supported by the scat. The maximized stresses are distributed over several interlaminar shear areas on a ball manufactured out of typical two dimensionally woven cloth laminate, which under the harsh conditions yields one or more interlaminar shear areas. A high strength frac ball manufactured out of relatively thick three dimensionally woven cloth laminate, transfers the stresses into the strong reinforcement material and away from the few interlaminar shear areas. In many cases, the ball diameter is small enough to be manufactured out of just one three dimensionally woven cloth laminate with no interlaminar shear layers; therefore, all the high contact stresses are directly transferred to the strong reinforcement material. Three dimensionally woven material is better suited for this type of application since the orientation of a typical layered laminate with respect to the ball seat is not predictable. Furthermore, common composite frac balls do not offer the necessary strengths required in oil and gas wellbore use. The lack of fiber reinforcement in three directions and the large number of interlaminar shear areas are directly responsible for the poor performance of composite balls used in wellbore applications.

In an embodiment, the frac ball of this disclosure is designed to alleviate the interlaminar shear limitations found in balls manufactured by typical composite laminates. The frac ball is manufactured by at least one, relatively thick, three dimensionally woven cloth used as the laminate reinforcement. Each additional layer of reinforcement produces one interlaminar shear area, which weakens the laminate; hence the fewer layers, the stronger the laminate. The strongest laminate is manufactured using one relatively thick three dimensionally woven reinforcement cloth, having no interlaminar shear layers.

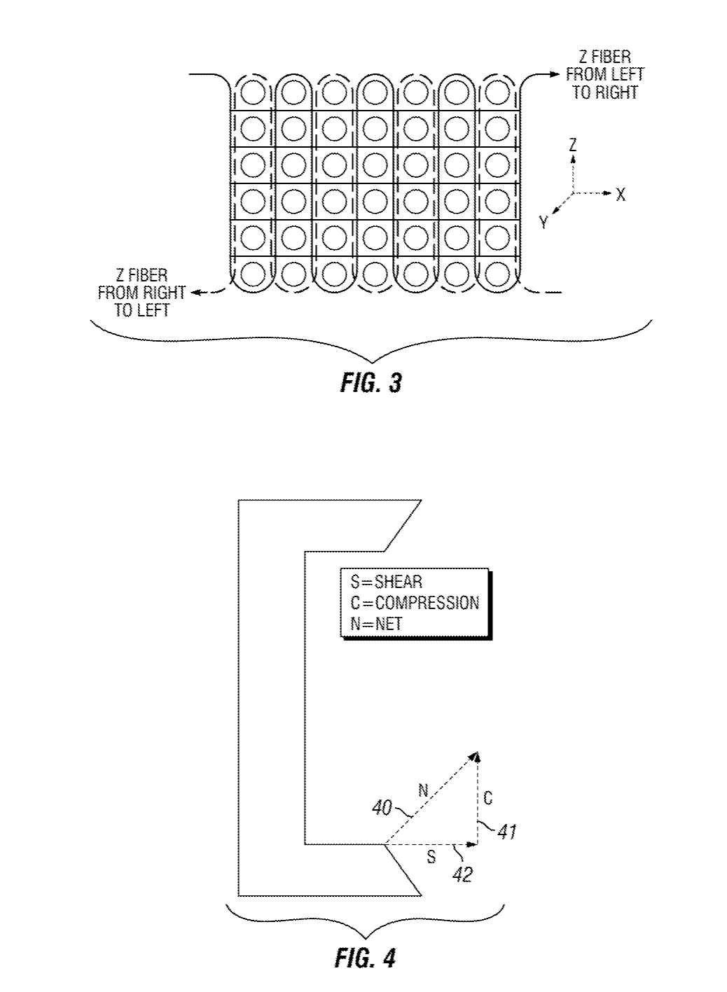

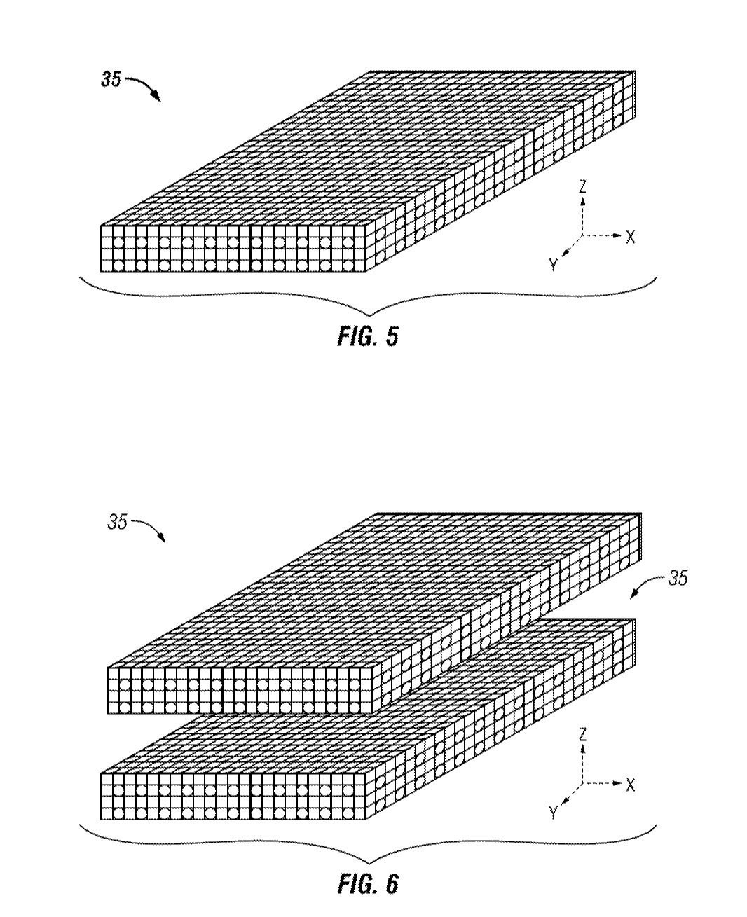

In an embodiment, three dimensionally woven reinforcing plate is manufactured by weaving equal amounts of “X” and “Y” fibers, in layers, which are secured together by the “Z” fiber. The “Z” fiber is woven up and around then down and around all “Y” fibers (see FIG. 3). Relatively thick plate material may also be manufactured by stacking/layering several two dimensionally woven cloths on top of one another and stitching them together. This stitching does not provide reinforcement in the “Z” directions as would a woven fiber on three dimensionally woven plate material (see FIGS. 3 and 5).

As discussed above, typical three dimensionally woven reinforcement plate material usually contains substantially equal amounts of fiber in both the “X” and “Y” directions which are both held in place by a much smaller percentage of fiber in the “Z” direction. The “Z” direction fiber, while typically containing 3 to 10% of the total fiber, adds significant strength in two directions. Without the “Z” fiber, the “X” and “Y” fibers would rely solely on the resin 14 for shear resistance. The addition of even a small percentage of“Z” fiber (38 and 39 in FIGS. 14 and 15) greatly increases the materials resistance to shear. Without the “Z” fiber, a condition similar to FIG. 2B would exist; “X” and “Y” fiber layers subjected to loads 44 and 43 would be held entirely together by the resin 14 (FIG. 14). The secondary gain in strength is in the “Z” direction itself. As shown in FIGS. 14 and 15, resin 14 maintains the “Z” fibers 38, 39 in place allowing an applied load 45 to be carried by the stiffness of the fibers 38, 39 and not the compressive strength of just the resin 14.

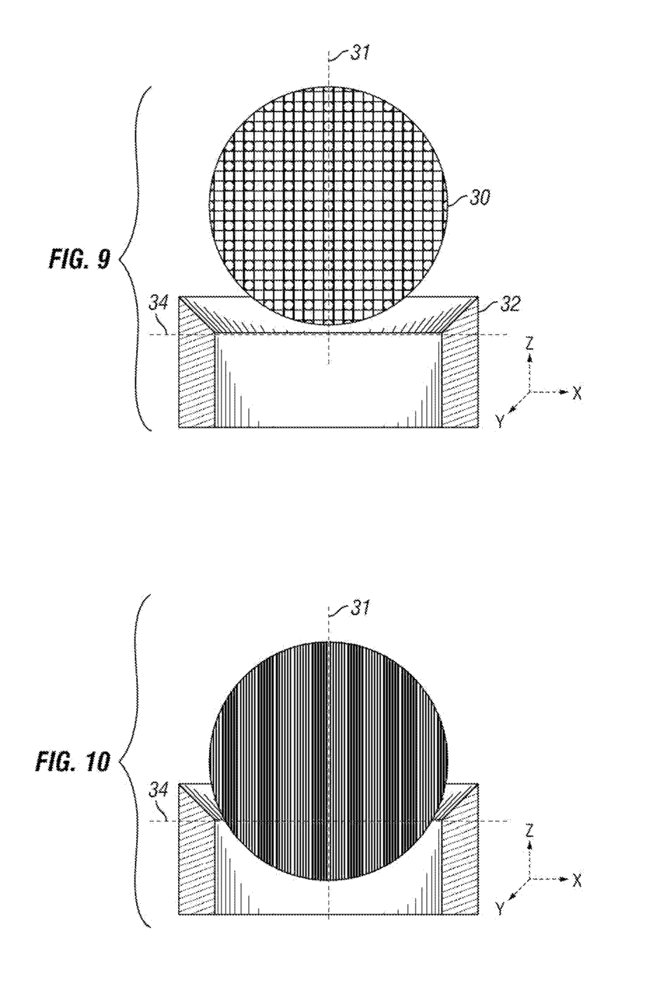

Resin 14 helps maintain the “Z” fibers 38, 39 (FIGS. 14 and 15) in place and therefore these fibers 38, 39 are able to transfer the load through the ball 30 into the scat 32 (FIG. 9); however, the stiffness of the fiber 38, 39 will determine just how much load it may withstand. The stiffness of any material is determined by the material's Tensile or Young's Modulus. The higher the fiber's modulus, the stiffer the material; i.e., the higher the amount of compressive load 45 that material may withstand before yielding under load per unit area. A metal alloy used for oilfield applications having, for example, minimum yield strength of 80 ksi (4140 or L80) has a tensile modulus of approximately 29700 ksi. The fiber glass used to manufacture the three dimensionally woven reinforced plate has a tensile modulus of just less than 1.2000 ksi, while carbon fiber has a tensile modulus of 33500 ksi.

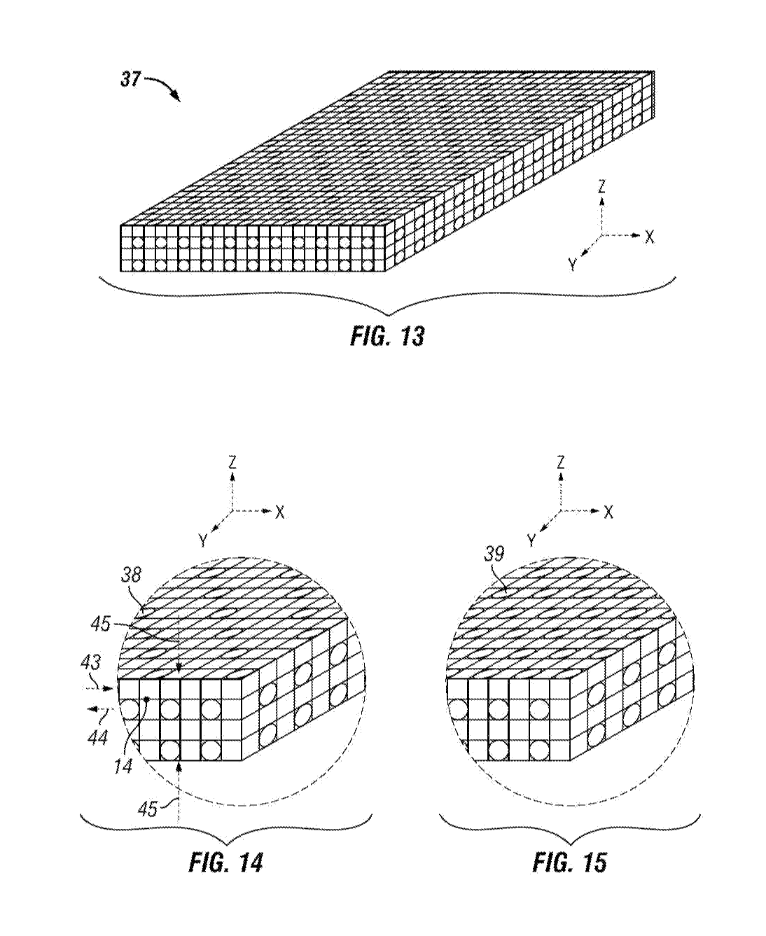

As an example, if the objective is to develop a three dimensionally woven reinforcement plate material with equal strength in all three axes, the optimal amount of “Z” fiber needed to produce such a plate is 33%, i.e., 100% divided by 3. Using common fiber glass (e.g. e-glass), the percentages are quite simple, 33% in each of the three directions, X, Y and Z, as illustrated in FIG. 5. The addition of carbon allows the manufacturer to produce a plate (FIG. 13) with equal strengths in each direction while using a smaller percentage in the “Z” and cutting down on weight at the same time. Because carbon has a modulus of almost three times that of e-glass the percentage of fabric in the “Z” direction may be much lower than 33% and still provide a relatively strong plate in all directions, X, Y, Z. In such embodiments, optimal amounts of carbon in the “Z” direction are 14-15%.

Using specialized manufacturing equipment, it is possible to weave a relatively thick plate containing, for example, 33% of the fibers in each of the three axes. Manufacturing plate material with equal amounts of fiber in each direction is not a standard process; therefore, using only carbon in the “Z” direction minimizes the percentage of fiber required in the “Z” direction, while providing approximately equal strength, and minimizing the overall weight.

The three dimensionally woven composite ball 30 as shown in FIG. 9 is subjected to compressive 41 and shear 42 loading along axis 31-31, when in contact with its associated ball seat 32. The compressive 41, shear 42 and resulting net 40 forces acting on a ball are detailed in FIG. 4. The reinforcement plate 35 (FIGS. 5 and 6, 3D plate versus cloth in two dimensionally woven material) used to make the composite ball is a three dimensionally woven material. The plate is woven with roving in three directions, represented by the axes X, Y, and Z in FIG. 5. The X-axis represents left to right, the Y-axis represents in and out of the page and the Z-axis represents top to bottom. The equipment used to manufacture the three dimensionally woven plates determines the limitations of the plate's thickness; it also determines the percentage of fibers in the “Z” direction, with respect to the equal amounts of fibers in both “X” and “Y” directions.

Manufacturing Method. In an embodiment, a three dimensionally woven reinforcement plate is cut into sections and stacked one on top of another in a mold (FIG. 8) or as entire plates layered one on top of one another (FIG. 6), in order to create a thicker laminate capable of producing any size ball required for large wellbore diameters.

In an embodiment, three dimensionally woven reinforcement plate sections are stacked into a compression mold and subjected to a wide range of compression percentages. A minimally compressed three dimensionally layered billet (typically, a billet is cured laminate in tubular or cylindrical form versus rectangular/square plate laminate) produces a near zero-compressed “Z” fiber laminate, which maximizes the reinforcement strength in all directions. It also results in the least amount of material used per billet, thereby a lighter ball.

A heavily compressed three dimensionally woven laminate produces a heavy billet and most likely exhibits weaker strengths in the all fiber directions. The weaker laminate is partly due to the compression of the “Z” fiber 38, 39 (FIGS. 14 and 15) and partly due to lower resin contents. In either case, the billets may be created by pouring resin in between the layers of reinforcement or vacuum infusing the resin into the mold after stacking is complete, followed by compressing the billet to a predetermined state (easily achieved using a press) and concluded by the curing process.

Manufacturing near zero-compression plate laminate is less involved. If no compression is required, the entire reinforcement plate material (without cutting into sections) is placed into a mold or vacuum bagged, with measures taken to ensure the bag or mold itself will not induce compression once a vacuum is induced (for example, atmospheric pressure pushing on the vacuum bag may compress the material inadvertently). In an embodiment, due to the plate's thickness, the resin is vacuum assisted into the plate material while the air is concurrently removed. If a relatively small percent of compression is required, spacers may be used to take up a small amount of the space normally reserved for the three dimensionally woven plate material, since in this case, a press is not used to perform the compression. As the vacuum is drawn in the mold or bag, the largest possible load is produced by the atmospheric pressure acting on the surface area of the mold or bag, which limits the percent of compression.

If a higher compression percentage is required on plate material, a press may be required. A mold or modified vacuum bag may be used along with the press in order to apply the necessary amount of load required to achieve the higher percent compression. This approach may be used to produce a relatively high compression percentage; however, maintaining the compression plate parallel to the plate material, while compressing, is vital in producing a uniformly compressed laminate. In general, highly compressed three dimensionally woven reinforced laminate material is produced in a compression mold, via stacked sections of plate material as described above.

In certain cases, specific gravity (ratio of the weight of ball vs. that of water) of a three dimensionally woven reinforced ball is increased, which is achieved by compressing the “Z” fibers 38, 39 as shown in FIGS. 14 and 15. A ball with relatively high specific gravity has advantages in certain wellbore conditions; these conditions include but are not limited to presence of heavy drilling fluids or the inability to pump the ball onto a seat in a vertical to highly deviated wellbore. The heavier the ball, the denser the wellbore fluids may be without making the ball to float. A heavier ball travel faster through the relatively long distance down to the ball seat. The heavier compressed laminate most likely have weaker material properties, due to reasons stated above. However, the higher specific gravity ball is application-specific which may not require the better material properties produced by a slight to zero compressed three dimensionally woven reinforced laminate. The use of 100% e-glass (33% in each direction) provide the heaviest uncompressed reinforcement billet. The density of e-glass is approximately 30% higher than that of carbon fiber.

In general, if the three dimensionally woven reinforcement plate is thick enough, the ball diameters are small enough, and laminate with high specific gravities are not required, the three dimensionally woven reinforcement material may be used as is.

In an embodiment, a single three dimensionally woven plate as laminate reinforcement without axial layering is used. The three dimensionally woven reinforcement composite ball may withstand as much as three times the compressive and shear stresses compared to a two dimensionally woven reinforcement composite ball having high number of interlaminar layers and lack of “Z” fiber support. In addition to the strength characteristics, thick three dimensionally woven plate is the most efficient material available for laminate production; regardless of the method used, compression molding or plate infusion (VARTM).

Mechanism. Without wishing to be limited by any theory, an explanation of the superior performance (e.g., the high load it is able to withstand) of a three dimensionally woven reinforced composite frac ball in comparison to a two dimensionally woven reinforced composite is shown in FIGS. 10 and 11. Two dimensionally woven cloth reinforcement is relatively thin, which creates a large number of interlaminar layers. Interlaminar shear strength is determined by the properties of the resin and is by far the weakest of the material properties for a laminate. The ball in FIG. 11, is manufactured out of one plate of three dimensionally woven reinforced laminate; therefore, no interlaminar shear areas, versus the large quantity of shear areas on the ball in FIG. 10. A laminate manufactured from a thick three dimensionally woven reinforcement plate, regardless of fiber type in the “Z” or the associated percentage, will have superior interlaminar shear characteristics when compared to a laminate manufactured out of two dimensionally woven cloth.

Again in FIG. 10, the two dimensionally woven reinforced ball lands on the ball seat, which is typically made out of metal, and as the fluid pressure is increased from above, the mechanical loading on the ball increases accordingly. Since two dimensionally woven reinforced balls typically have a large number of interlaminar layers and due to the absence of fibers in all three directions, the balls typically may not withstand the combined shear and compression stresses (see FIG. 4). In addition to the weaker two dimensionally woven reinforcement, the ball seat ID is usually maximized to allow the passage of preceding smaller balls and to maximize the flow through area of the scat. The maximized seat ID leads to large contact stresses on the composite ball due to the minimized contact area. The high contact stresses will most likely act on several of the interlaminar layers at one time, due to the quantity of these layers, which leads to failure of the composite material.

Certain applications require the use of composite balls in Oil and Gas wellbores, mostly due to the relatively light weight and the unique drill-ability characteristic. The introduction of three dimensionally woven plates as the reinforcement on composite balls has increased the shear and compressive strength enough to be used on high stress applications.

In FIG. 11 the ball is in position on the ball seat, as the fluid pressure is increased from above, high contact stresses are produced; however, in this case the contact stresses are either not directly in contact with a interlaminate shear layer or only contacts one layer versus multiple, as on the two dimensionally woven reinforced ball. The addition of the 3^{rd} dimensional fibers or “Z” fibers assure support in all directions, regardless of the orientation the interlaminar shear layers.

Since the weakest area on a layered composite ball is in the interlaminar shear layers, the worst case scenario for any layered ball occurs when the layers are orientated perpendicular to the ball seat plane 34, see FIG. 10. Under this orientation the resin is placed in an almost pure shear condition, which most likely yields one or several of the layers, which will most likely result in layers shearing off; thereby, allowing the fluid from above to bypass the damaged ball. The three dimensionally woven reinforced layered balls have at most only one interlaminar shear layer, resulting in an inherently stronger ball.

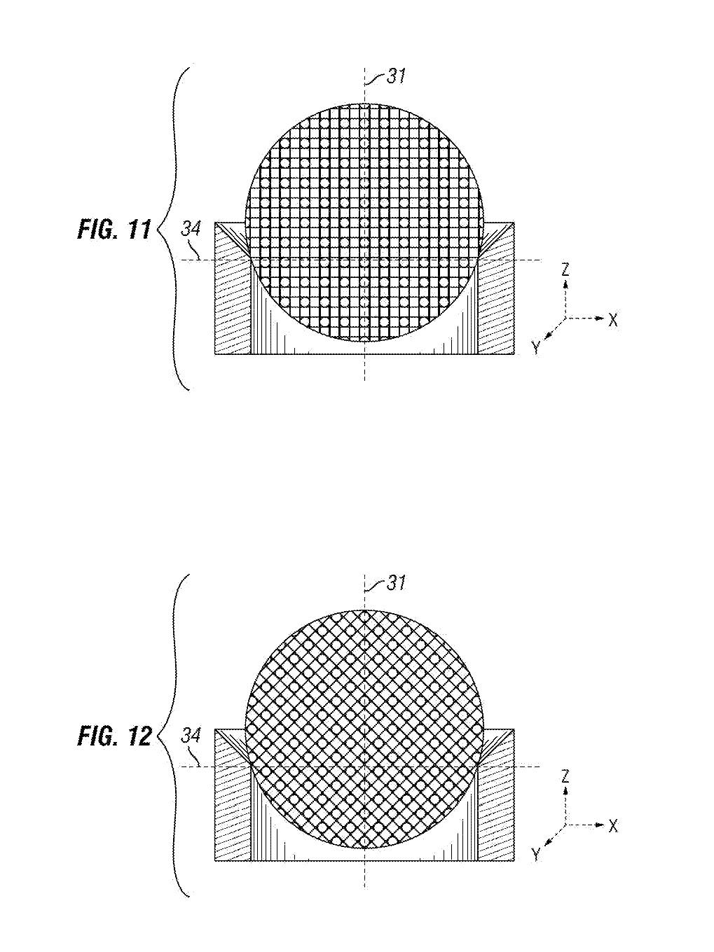

Layered composite balls using three dimensionally woven reinforcement withstand the combined high compressive and shear stresses created by the maximized ID of the metal ball seat; however, if the reinforcement laminate is thick enough to be used as is without layering, the resulting ball does not contain any inherently weak interlaminar layers. In this case, since the three dimensionally woven reinforcement laminate supports the ball in all three directions as shown in FIG. 12, the orientation of the ball with regard to the scat is inconsequential.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations. The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of and the like.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The inclusion or discussion of a reference is not an admission that it is prior art to the present invention, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

What is claimed is:

1. A frac ball comprising three orthogonal axes x, y, and z; wherein said frac ball has approximately equal strength in each direction of said three axes x, y, and z.

2. The frac ball of claim 1 comprising a resin.

3. The frac ball of claim 1 comprising glass fibers or carbon fibers or both.

4. The frac ball of claim 1 comprising an equal amount of glass fibers in each direction of said x, y, and z axes.

5. The frac ball of claim 1 comprising glass fibers in the x and y axes and carbon fibers in the z axis.

6. The frac ball of claim 1 comprising no interlaminar layers.

7. The frac ball of claim 1 wherein said frac ball has different diameters.

8. A method of producing a frac ball wherein said frac ball comprises three orthogonal axes x, y, and z and wherein said frac ball has approximately equal strength in each direction of said three axes x, y, and z.

9. The method of claim 8 comprising producing said frac ball out of a billet.

10. The method of claim 9 wherein said billet is created by stacking layers of three dimensionally woven laminate;
adding resin in between said laminate layers;
compressing said stack of laminate layers with resin; and
curing the compressed stack.

11. The method of claim 9 wherein said billet comprises only one layer of three dimensionally woven laminate and no interlaminar layers.

12. The method of claim 8 further comprising producing frac balls of different diameters.

13. The method of claim 8 wherein said frac ball comprises glass fibers or carbon fibers or both.

14. The method of claim 8 wherein said frac ball comprises an equal amount of glass fibers in each direction of said x, y, and z axes.

15. The method of claim 8 wherein said frac ball comprises glass fibers in the x and y axes and carbon fibers in the z axis.

16. A method of using a frac ball wherein said frac ball comprises three orthogonal axes x, y, and z and wherein said frac ball has approximately equal strength in each direction of said three axes x, y, and z.

17. The method of claim 16 comprising utilizing said frac ball to service an oilwell.

18. The method of claim 16 comprising utilizing said frac ball in horizontal drilling.

19. The method of claim 16 comprising utilizing said frac ball in multi-zone completion.

20. The method of claim 16 comprising utilizing more than one of said frac balls of different sizes.
